(19) United States
(12) Patent Application Publication
(10) Pub. No.: US 2024/0254596 A1
(43) Pub. Date: Aug. 1, 2024

(54) ALUMINUM-MAGNESIUM-LITHIUM-SCANDIUM ALLOYS FOR ADDITIVE MANUFACTURING

(71) Applicant: SRL Holding Company Pty Ltd, Melbourne (AU)

(72) Inventor: Timothy James Langan, Catonsville, MD (US)

(21) Appl. No.: 18/426,137

(22) Filed: Jan. 29, 2024

Related U.S. Application Data
(60) Provisional application No. 63/441,820, filed on Jan. 29, 2023.

(51) Int. Cl. C22C 21/06; B22F 10/64; B33Y 10/00; B33Y 40/20; B33Y 70/00

(52) U.S. Cl. CPC C22C 21/06; B22F 10/64; B33Y 10/00; B33Y 40/20; B33Y 70/00; B22F 2301/052; B22F 2998/10

(57) ABSTRACT

Aluminum alloys including Mg, Li and Sc used to make additively manufactured articles are disclosed. The Al—Mg—Li—Sc alloys may be provided as additive manufacturing feedstock in the form of powders, flakes, wires, rods and the like. Once deposited and built up into desired shape, the alloys may be heat treated and/or artificially aged to achieve desirable microstructures and mechanical properties.

### CROSS-REFERENCE TO RELATED APPLICATION

This application claims the benefit of U.S. Provisional Patent Application No. 63/441,820 filed Jan. 29, 2023, which is incorporated herein by reference.

### FIELD OF THE INVENTION

The present invention relates to Al—Mg—Li—Sc alloys for additive manufacturing. The alloys can be fabricated in various forms including powder, flake, wire, rod, bar and the like. The additive manufacturing process may utilize a heat source such as localized, laser, electron beam and arc heat sources and/or bulk heat sources to melt the alloy feedstock and build a structure. The invention also relates to thermal heat treatments and aging steps that may be used to process the deposited alloy structure.

### BACKGROUND INFORMATION

Additive manufacturing approaches have been developed to fabricate net shaped and near net shaped components and structures. Advanced wrought aluminum alloys such as Al—Mg and Al—Cu alloys AA7075, AA7055 and AA2095 having low densities and high strengths are possible candidates for high performance additive manufacturing applications. However, low resistance to solidification cracking and quench sensitivity have restricted such high performance alloys from use in additive manufacturing applications.

### SUMMARY OF THE INVENTION

Aluminum alloys including Mg, Li and Sc are used to make additively manufactured articles. The Al—Mg—Li—Sc alloys may be provided as additive manufacturing feedstock in the form of powders, flakes, wires, rods and the like. Once deposited and built up into desired shape, the alloys may be heat treated and/or artificially aged to achieve desirable microstructures and mechanical properties.

An aspect of the present invention is to provide an additively manufactured article comprising an aluminum alloy comprising from 2 to 7 weight percent Mg, from 0.2 to 3 weight percent Li, from 0.05 to 1 weight percent Sc, from zero to 1 weight percent Ag, from zero to 1 weight percent Zn, from zero to 1 weight percent Zr, and from zero to 1 weight percent Ti, the balance comprising Al and incidental impurities.

Another aspect of the present invention is to provide an aluminum alloy feedstock material for additive manufacturing comprising from 2 to 7 weight percent Mg, from 0.2 to 3 weight percent Li, from 0.05 to 1 weight percent Sc, from zero to 1 weight percent Ag, from zero to 1 weight percent Zn, from zero to 1 weight percent Zr, and from zero to 1 weight percent Ti, the balance comprising Al and incidental impurities.

A further aspect of the present invention is to provide a method of additively manufacturing an article comprising providing an aluminum alloy feedstock material comprising from 2 to 7 weight percent Mg, from 0.2 to 3 weight percent Li, from 0.05 to 1 weight percent Sc, from zero to 1 weight percent Ag, from zero to 1 weight percent Zn, from zero to 1 weight percent Zr, and from zero to 1 weight percent Ti, the balance comprising Al and incidental impurities, and subjecting the aluminum alloy feedstock material to an additive manufacturing process to produce the article.

These and other aspects of the present invention will be more apparent from the following description.

### BRIEF DESCRIPTION OF THE DRAWING

FIG. 1 is a graph showing hardness after heat treatment and artificial aging of an as-deposited Al—Mg—Li—Ag—Si—Zr alloy structure.

### DETAILED DESCRIPTION

The present aluminum alloys for additive manufacturing include Mg, Li and Sc in controlled amounts. The Al—Mg—Li—Sc alloys may comprise selected amounts of Ag, Zn, Zr and/or Ti.

Magnesium may be present in an amount of at least 2 weight percent, for example, at least 2.5 weight percent, or at least 3 weight percent. Magnesium may be present in an amount of less than 7 weight percent, for example, less than 8 weight percent, or less than 5 weight percent. Magnesium may be present in an amount from 2 to 7 weight percent, for example, from 2.5 to 6 weight percent, or from 3 to 5 weight percent.

Lithium may be present in an amount of at least 0.2 weight percent, for example, at least 1 weight percent, or at least 1.5 weight percent, or at least 2 weight percent. Lithium may be present in an amount of less than 3 weight percent, for example, less than 2.8 weight percent, or less than 2.6 weight percent, or less than 2.5 weight percent. Lithium may be present in an amount from 0.2 to 3 weight percent, for example, from 1 to 2.8 weight percent, or from 2 to 2.5 weight percent.

Scandium may be present in an amount of at least 0.05 weight percent, for example, at least 0.08 weight percent, or at least 0.1 weight percent, or at least 0.15 weight percent, or at least 0.2 weight percent, or at least 0.5 weight percent. Scandium may be present in an amount of less than 1 weight percent, for example, less than 0.9 weight percent, or less than 0.8 weight percent, or less than 0.6 weight percent, or less than 0.5 weight percent, or less than 0.4 weight percent. Scandium may be present in an amount from 0.05 to 1 weight percent, for example, from 0.08 to 1 weight percent, or from 0.1 to 1 weight percent, or from 0.1 to 0.5 weight percent. For example, when the Al—Mg—Li—Sc alloy feedstock is provided in wire or rod form, the Sc may comprise from 0.1 to 0.3 weight percent, or from 0.15 to 0.25 weight percent, or about 0.2 weight percent. When the Al—Mg—Li—Sc alloy feedstock is provided in powder or other particulate form, the Sc may comprise from 0.55 to 1 weight percent, or from 0.6 to 0.95 weight percent, or from 0.7 to 0.9 weight percent, or about 0.8 weight percent.

Exemplary Al—Mg—Li—Sc alloy compositions are listed in Table 1. Zirconium, titanium and zinc may be included individually in amounts as shown in Table. 1

TABLE 1
Al—Mg—Li—Sc Compositions (wt %)

| Composition | Mg | Li | Sc | Ag | Zr/Ti/Zn |
|---|---|---|---|---|---|
| A | 2-7 | 0.2-3 | 0.05-1 | 0-1 | 0-1 |
| B | 2.5-6 | 1-2.8 | 0.08-1 | 0.1-0.8 | 0.05-0.8 |
| C | 3-5 | 1.5-2.6 | 0.1-0.95 | 0.2-0.6 | 0.1-0.7 |
| D | 3.5-4.5 | 2-2.5 | 0.15-0.9 | 0.3-0.5 | 0.1-0.5 |
| E | 4 | 2.3 | 0.8 | 0.4 | 0.14 Zr |
| F | 4 | 2.3 | 0.2 | 0.4 | 0.14 Zr |

The Al—Mg—Li—Sc alloy may be melted and either solidified into powder, flake or ribbon, or cast into billet. Billet may be extruded into bloom—rolled to redraw rod—drawn to wire, or extruded to redraw rod—drawn to wire, or extruded directly into wire. Alternatively, the alloy may be cast directly into a bloom that may be rolled to redraw rod—drawn to wire.

In one embodiment the billet, bloom and/or redraw wire may be heat treated to optimize drawing. Heat treatments may be selected to optimize microstructure by coarsening the scandium, lithium and magnesium containing precipitates and removing cold work.

The Al—Mg—Li—Sc alloy may be used as feedstock for various additive manufacturing processes. The feedstock may be provided in rod form, i.e., rod, wire, bar, filament, ribbon, etc., form. The feedstock may be provided in particulate form, i.e., powder, flake, chopped ribbon, pellet, slurry, etc., form. The Al—Mg—Li—Sc alloy feedstock such as powder, flake, ribbon, rod, bar or wire, may be used in an additive manufacturing process by melting with a local heat source (e.g., laser, arc, electron beam, cold spray) and then deposited to form a preform or structure and/or deposited as a green preform structure, followed by bulk or localized heating. After deposition heat treatment and/or aging schedules can be used to optimize properties. In certain embodiments, the deposited aluminum alloy is not subjected to post-deposition quenching and/or is not subjected to post-deposition cold working such as stretching.

The deposited Al—Mg—Li—Sc alloy may be subjected to heat treatment. In one embodiment, a multistep heat treatment schedule may be used to precipitate the scandium into strengthening dispersoids at first temperatures in the range of from 225 to 275° C., or from 250 to 350° C., or from 275 to 325° ° C., then precipitate the zirconium at second temperatures in the range of from 325 to 475° C., or from 350 to 450° C., or from 375 to 425° C., followed by optionally solutionizing the other alloying elements at a third temperature above 425° C., or above 450° C., or above 475° C., up to a temperature below the liquidus of the alloy. In one embodiment, the material is allowed to cool slowly after the heat treatment to avoid residual stresses. In another embodiment, the material is quenched after the heat treatment. The structure can be used in the as heat treated condition or it can be artificially or naturally aged.

In one embodiment, artificial aging of the heat treated deposit may be performed in a single step or in multiple steps, for example, at temperatures between 100 to 250° C.

In another embodiment the deposit may be artificially or naturally aged without a heat treatment step. Artificial aging of the as deposited material can be performed in a single step or in multiple steps, for example, at temperatures between 100 to 250° C.

The following examples are intended to illustrate various aspects of the present invention, and are not intended to limit the scope of the invention.

### Example

An aluminum alloy with a target composition in weight percent of Al-4.0Mg-2.3Li—0.4Ag-0.2Sc-0.14Zr was cast into 3.7 inch diameter billet under argon cover. The measured composition of the billet was Al-4.15Mg-1.69Li—0.37Ag-0.19Sc-0.13Zr. The billet was extruded through a ⅛-inch diameter 10 hole die. The resultant ⅛-inch diameter AlMgLiAgScZr alloy extruded rods were used a electrodes to deposit a wall structure onto an aluminum alloy substrate. A 4-inch long by ½-inch wide and ½ inch tall wall was built layer-by-layer on the 3/16-inch thick aluminum substrate. TIG welding parameters used included: 155 amp AC TIG, with varying wave balance with a 20 CFH argon cover.

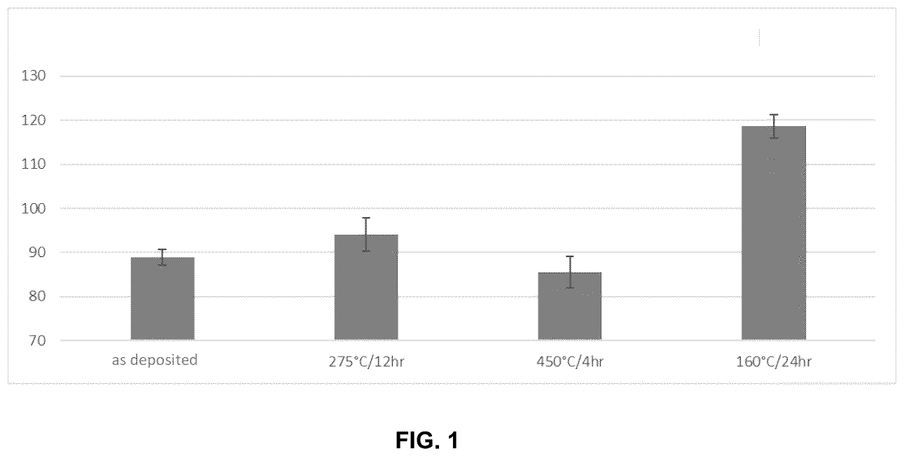

The measured composition in the deposited structure was Al-3.94Mg-1.71Li-0.36Ag-0.20Sc-0.13Zr. After deposition the wall structure was heat treated/aged to improve mechanical properties. A two-step heat treatment was used: (1) 12 hrs at 275° C. air cooled to room temperature; and (2) 4 hrs at 450° ° C. air cooled to room temperature. Artificial aging was then performed for 24 hrs at 160° C. Hardness was measured after each stage of the heat treatment/aging schedule. FIG. 1 shows that hardness increased from HV 85 in the as-deposited structure up to HV 119 after heat treatment/artificial aging.

Any suitable presently available or future additive manufacturing technique operable to form the Al—Mg—Li—Sc alloy into a desired article may be used. Non-limiting examples of additive manufacturing techniques include directed energy deposition, powder bed fusion, binder jetting, powder metallurgy jetting, metal lithography, mold slurry deposition, cold spraying, friction deposition, and/or sheet lamination.

Directed energy deposition is an additive manufacturing process in which focused thermal energy is used to fuse materials by melting as they are being deposited. A nozzle mounted on a multi-axis arm (e.g., 3, 4, or 5 axes) deposits a material on a base or a component. The feed material may be in the form of rod, particulates, and the like. As the material is deposited, the material may be melted by a heat source such as focused thermal energy (e.g., an electron beam, a laser, an arc, and/or the like). This process may continue repeatedly until the layers have solidified.

Non-limiting examples of powder bed fusion processes include, for example, selective laser sintering (SLS), selective laser melting (SLM), direct metal laser sintering (DMLS), and electron beam melting (EBM).

Binder jetting may include selectively jetting droplets of liquid binder onto a bed of the Al—Mg—Li—Sc powder or flake based on a 3D model of a component, adhering the particles into a cross-section, depositing additional particles then binder to form the next layer of the article and repeating this process until a green component is finished. For example, a binder jetting apparatus may spread a layer of the Al—Mg—Li—Sc particles in a build box, a printhead may move over the particle layer depositing liquid binder according to design parameters for that layer, the layer may be dried, the build box may be lowered, a new layer of particles may be spread, and the process is repeated until the green article is completed.

Material jetting is an additive manufacturing process in which droplets of feedstock material are selectively deposited. The feedstock material may be metal, ceramic, photosensitive material, and/or the like. The feedstock material may be deposited layer by layer, and the process repeats until the part is completed.

Material extrusion is an additive manufacturing process in which material is selectively dispensed through a nozzle or orifice. The nozzle may be heated such that as the material is being extruded through the nozzle, the material is melted. The feed material may be in filament form, such that the filament is fed to the nozzle from a coil of material. The melted material is deposited layer by layer. The nozzle may move along the x and y axes. The platform in which the material is deposited may move along the z axis between each layer. This process repeats until the part is completed.

Sheet lamination is an additive manufacturing process in which sheets of material are bonded to form a part. A sheet may be cut using a laser or knife, and each layer may be joined to the preceding layer by welding or applying an adhesive. This process repeats until the part is completed.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step.

As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. An additively manufactured article comprising a deposited aluminum alloy comprising:
from 2 to 7 weight percent Mg;
from 0.2 to 3 weight percent Li;
from 0.05 to 1 weight percent Sc;
from zero to 1 weight percent Ag;
from zero to 1 weight percent Zn;
from zero to 1 weight percent Zr; and
from zero to 1 weight percent Ti, the balance comprising Al and incidental impurities.

2. The additively manufactured article of claim 1, wherein the aluminum alloy comprises from 2.5-6 weight percent Mg, from 1. to 2.8 weight percent Li, from 0.1 to 0.95 weight percent Sc, and from 0.1 to 0.6 weight percent Ag.

3. The additively manufactured article of claim 1, wherein the Sc comprises less than 0.5 weight percent.

4. The additively manufactured article of claim 3, wherein the Sc comprises from 0.1 to 0.3 weight percent.

5. The additively manufactured article of claim 1, wherein the Sc comprises greater than 0.5 weight percent.

6. The additively manufactured article of claim 5, wherein the Sc comprises from 0.6 to 0.95 weight percent.

7. The additively manufactured article of claim 1, wherein the aluminum alloy comprises from 0.05 to 0.8 weight percent Zr, Ti or a combination thereof.

8. The additively manufactured article of claim 1, wherein the deposited aluminum alloy is heat treated.

9. The additively manufactured article of claim 8, wherein the heat treated deposited aluminum alloy is artificially aged.

10. The additively manufactured article of claim 8, wherein the heat treated deposited aluminum alloy has been subjected to multiple-step heat treatment.

11. The additively manufactured article of claim 10, wherein the multiple-step heat treatment comprises a first step conducted at a first temperature, a second step conducted at a second temperature, and a third step conducted at a third temperature, wherein the first temperature is less than the second temperature, and the third temperature is less than the first temperature.

12. The additively manufactured article of claim 8, wherein the deposited aluminum alloy is not subjected to quenching after deposition or after heat treating.

13. The additively manufactured article of claim 8, wherein the deposited aluminum alloy is not subjected to cold working after deposition or after heat treating.

14. The additively manufactured article of claim 1, wherein the deposited aluminum alloy is artificially aged.

15. An aluminum alloy feedstock material for additive manufacturing comprising:
from 2 to 7 weight percent Mg;
from 0.2 to 3 weight percent Li;
from 0.05 to 1 weight percent Sc;
from zero to 1 weight percent Ag;
from zero to 1 weight percent Zn;
from zero to 1 weight percent Zr; and
from zero to 1 weight percent Ti, the balance comprising Al and incidental impurities.

16. The aluminum alloy feedstock material for additive manufacturing of claim 15, wherein the aluminum feedstock material is in rod form.

17. The aluminum alloy feedstock material for additive manufacturing of claim 16, wherein the aluminum alloy comprises less than 0.5 weight percent Sc.

18. The aluminum alloy feedstock material for additive manufacturing of claim 15, wherein the aluminum alloy feedstock material is in particulate form.

19. The aluminum alloy feedstock material for additive manufacturing of claim 18, wherein the aluminum alloy comprises greater than 0.5 weight percent Sc.

20. A method of additively manufacturing an article comprising:
providing an aluminum alloy feedstock material comprising:
from 2 to 7 weight percent Mg;
from 0.2 to 3 weight percent Li;
from 0.05 to 1 weight percent Sc;
from zero to 1 weight percent Ag;
from zero to 1 weight percent Zn;
from zero to 1 weight percent Zr; and
from zero to 1 weight percent Ti, the balance comprising Al and incidental impurities; and
subjecting the aluminum alloy feedstock material to an additive manufacturing process to produce the article.

21. The method of claim 20, wherein the additive manufacturing process includes depositing the aluminum alloy feedstock in multiple steps.

22. The method of claim 21, wherein the deposited aluminum alloy is heat treated.

23. The method of claim 22, wherein the heat treated deposited aluminum alloy is articially aged.

24. The method of claim 22, wherein the heat treated deposited aluminum alloy has been subjected to multiple-step heat treatment.

25. The method of claim 24, wherein the multiple-step heat treatment comprises a first step conducted at a first temperature of from 250 to 350° C., a second step conducted at a second temperature of from 350 to 450° ° C., and a third step conducted at a third temperature above 450° C.

26. The method of claim 22, wherein the deposited aluminum alloy is not subjected to quenching after depositing or after heat treating.

27. The method of claim 22, wherein the deposited aluminum alloy is not subjected to cold working after depositing or after heat treating.

28. The method of claim 21, wherein the deposited aluminum alloy is artificially aged.
